(19) United States
(12) Patent Application Publication
(10) Pub. No.: US 2012/0111002 A1
(43) Pub. Date: May 10, 2012

(54) CENTRIFUGAL COMPRESSOR AND TURBO SUPERCHARGER

(75) Inventor: Masakazu Tabata, Susono-shi (JP)

(73) Assignee: TOYOTA JIDOSHA KABUSHIKI KAISHA, Toyota-shi, Aichi (JP)

(21) Appl. No.: 13/381,296

(22) PCT Filed: Mar. 18, 2010
(86) PCT No.: PCT/JP2010/054673

§ 371 Date: Dec. 28, 2011

(51) Int. Cl. F02B 37/24; F04D 29/46

(52) U.S. Cl. 60/611; 415/148

(57) ABSTRACT

A compressor (2) comprises: a housing assembly (3) that includes a bearing housing (9) and a compressor housing (10), wherein a diffuser (6) is formed by a first diffuser wall portion (12) and a second diffuser wall portion (13) on outer periphery of an impeller (4), and a movable vane (15) that includes a base portion (17) which is arranged in a storage chamber (21) provided in the first diffuser wall portion (12) and has a facing surface (17a), and vane portions (18) which project from the facing surface (17a), wherein the movable vane (15) is movable between a projected position where the facing surface (17a) contacts with a positioning surface (20a) provided in the storage chamber (21) and the vane portions (18) project in the diffuser (6) and a retracted position where the vane portions (18) are housed in the storage chamber (21), wherein the bearing housing (9) is provided with a mounting surface (9a) located in a direction perpendicular to the direction of the axis (Ax), the compressor housing (10) includes an affixing portion (11) projecting further than the second diffuser wall portion (13), and a fastening surface (11a) being provided to the affixing portion (11) and located in a direction perpendicular to the direction of the axis (Ax), wherein the compressor housing (10) is assembled with the bearing housing (9) by attaching the fastening surface (11a) to the mounting surface (9a), and the positioning surface (20a) is provided in the storage chamber (21) so as to be flush with the fastening surface (11a).

### TECHNICAL FIELD

The present invention relates to a centrifugal compressor provided with a movable vane moving in and out of a diffuser passage, and a turbo supercharger having the centrifugal compressor.

### BACKGROUND ART

There is a known centrifugal compressor in which a vane movable between a position where it is projected into a diffuser passage and a position where it is housed in a housing chamber provided in a diffuser wall is provided in a diffuser portion (see Patent Literature 1).

### Citation List

### Patent Literature

Patent Literature 1: JP-A-2001-329996

### SUMMARY OF INVENTION

### Technical Problem

In the centrifugal compressor of the Patent Literature 1, the vane collides against an opposed side diffuser wall when the vane moves to reach the projected position. Thereby, there is a possibility that the vane is deformed in this moment and a part of the opposed side diffuser wall which has collided against the vane wears away. In order to prevent this problem, it is necessary that a clearance is formed between the opposed side diffuser wall and the vane when the vane reaches the projected position. However, when the clearance is large, a supercharging efficiency is decreased. Thus, it is necessary to decrease the clearance. The size of the clearance is decided by a length of the vane projecting in the diffuser at the projected position and a distance between the diffuser walls. Thereby, by managing sizes of portions to influence the clearance in the vane and the housing, it is possible to decrease the clearance. However, when the number of the portions the size of which are managed is large, it is laborious to manage the sizes thereof and production cost is increased.

In view of the foregoing, an object of the present invention is to provide a centrifugal compressor and a turbo supercharger, which can decrease the number of portions to be the sizes of which are managed for decreasing a size of a clearance between a vane existing at a projected position and a diffuser wall.

### Solution to Problem

A centrifugal compressor of the present invention comprises: a housing assembly that includes a first housing which supports a rotating shaft so as to be rotatable about an axis, the rotating shaft having an impeller on an end portion of itself, and a second housing which houses the impeller inside and is assembled with the first housing so as to be aligned in the direction of the axis with the first housing, wherein a diffuser serving as a passage space communicated with an exit side of the impeller is formed by a first diffuser wall portion of a first housing side and a second diffuser wall portion of a second housing side on outer periphery of the impeller, and a movable vane that includes a base portion which is arranged in a storage chamber provided in the first diffuser wall portion and has a facing surface opposing to the second diffuser wall portion, and vane portions which project from the facing surface to a second diffuser wall portion side, wherein the movable vane is movable in the direction of the axis between a projected position where the facing surface contacts with a positioning surface provided in the storage chamber and the vane portions project in the diffuser and a retracted position where the vane portions are retracted to a first diffuser wall portion side further than the projected position, wherein the first housing is provided with a mounting surface located in a direction perpendicular to the direction of the axis, the second housing includes an affixing portion projecting to the first housing side further than the second diffuser wall portion, and a fastening surface being provided to the affixing portion and located in a direction perpendicular to the direction of the axis, wherein the second housing is assembled with the first housing by attaching the fastening surface to the mounting surface, and the positioning surface is provided in the storage chamber so as to be flush with the fastening surface.

In the centrifugal compressor of the present invention, the positioning surface is flush with the fastening surface. Thereby, the size of a clearance between the movable vane in the projected position and the second diffuser wall portion is decided by two sizes which are the size of a distance in the direction of the axis between the fastening surface and the second diffuser wall portion and the size of a projecting length of the vane portion in the direction of the axis from the base portion. Thereby, according to the centrifugal compressor of the present invention, it is possible to decrease the number of portions to be managed about the size for decreasing the size of the clearance to two. By decreasing the number of the portions to be managed about the size to two in this manner, it is possible to suppress an influence which is given to the size of the clearance by a machining error of each portions and an assembly error. Thereby, it is possible to suppress varying the size of the clearance for each product. Further, by decreasing the number of the portions to be managed about the size, it is possible to easily manage the sizes of these portions. According to the centrifugal compressor of the present invention, since it is possible to manage the size of the clearance accurately, it is possible to decrease the size of the clearance while forming the clearance between the movable vane in the projected position and the second diffuser wall portion.

In one embodiment of the centrifugal compressor of the present invention, wherein the first diffuser wall portion may be provided with a concave portion hollowing in the direction of the axis further than the mounting surface and housing the base portion so as to be movable in the direction of the axis to become the storage chamber, the fastening surface may be attached to the mounting surface so that apart of the fastening surface covers at least a part of the concave portion, and the positioning surface may be the part of the fastening surface covering the concave portion. In this case, since the position of the movable vane in the projected position is decided directly by the fastening surface, it is possible to increase the positioning accuracy for the movable vane in the projected position. Thereby, it is possible to decrease the size of the clearance further while forming the clearance between the movable vane in the projected position and the second diffuser wall portion.

A turbo supercharger of the present invention comprises the centrifugal compressor mentioned above and a turbine, wherein the centrifugal compressor is provided to an intake passage of an internal combustion engine and the turbine is provided to an exhaust passage of the internal combustion engine, the turbine recovers exhaust energy of the internal combustion engine, and the turbo supercharger supercharges the internal combustion engine by driving to rotate the impeller of the centrifugal compressor by recovered exhaust energy.

According to the turbo supercharger of the present invention, since the turbo supercharger has the above mentioned centrifugal compressor, it is possible to decrease the number of the portions to be managed about the size for decreasing the size of the clearance between the movable vane in the projected position and the second diffuser wall portion to two. Thereby, it is possible to decrease the size of the clearance while forming the clearance between the movable vane in the projected position and the second diffuser wall portion. Accordingly, it is possible to suppress decreasing a supercharging efficiency when the movable vane reaches the projected position.

### BRIEF DESCRIPTION OF DRAWINGS

FIG. 1 is a view of a main part of a turbo supercharger in which a centrifugal compressor according to a first embodiment of the present invention is incorporated.

FIG. 2 is an enlarged view of a part around a diffuser.

FIG. 3 is an enlarged view of a movable vane.

FIG. 4 is an enlarged view of a part around a diffuser of a centrifugal compressor according to a second embodiment of the present invention.

### DESCRIPTION OF EMBODIMENTS

### First Embodiment

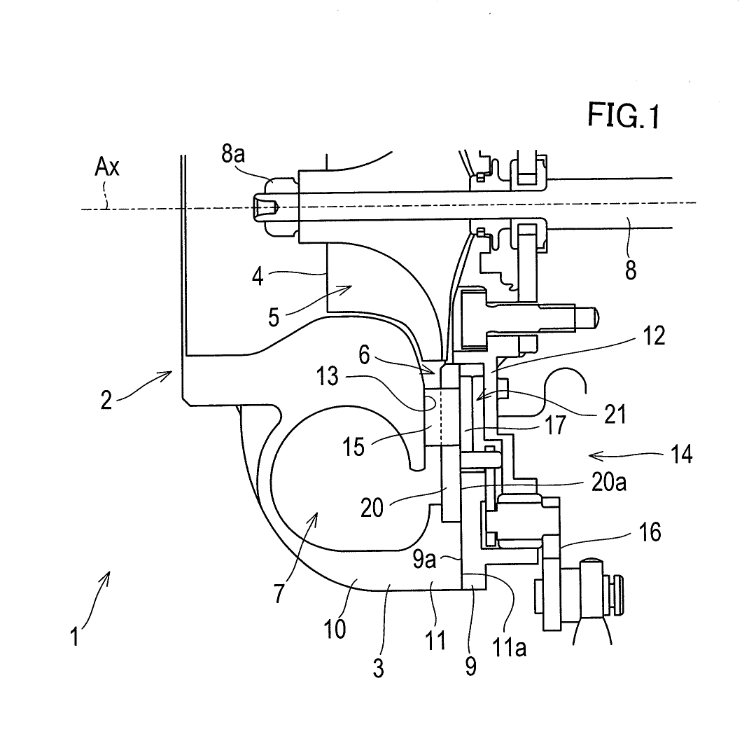

FIG. 1 shows a main part of a turbo supercharger in which a centrifugal compressor according to a first embodiment of the present invention is incorporated. The turbo supercharger 1 is attached to an internal combustion engine that is mounted on a vehicle as a traveling power source. The turbo supercharger 1 includes a centrifugal compressor 2 and a turbine (not shown). The turbine is similar to a turbine of a well known turbo supercharger. Thereby, illustration and description thereof will be omitted.

The compressor 2 has a housing assembly 3 and an impeller 4 housed in the housing assembly 3. The housing assembly 3 has a wheel chamber 5 in which the impeller 4 is housed, a diffuser 6 provided outward in a radial direction of the wheel chamber 4 as a passage space communicated with the exit side of the impeller 4, and a scrolled scroll chamber 7 provided outward in a radial direction of the diffuser 6 and communicated with the diffuser 6. The impeller 4 is fixed to an end portion of a rotating shaft 8 by a nut 8a, and rotates with the rotating shaft 8. A turbine wheel of the turbine is attached to the other end portion of the rotating shaft 8. These parts are the same as those of a well-known centrifugal compressor provided to a turbo supercharger, thus a detailed description thereof will be omitted.

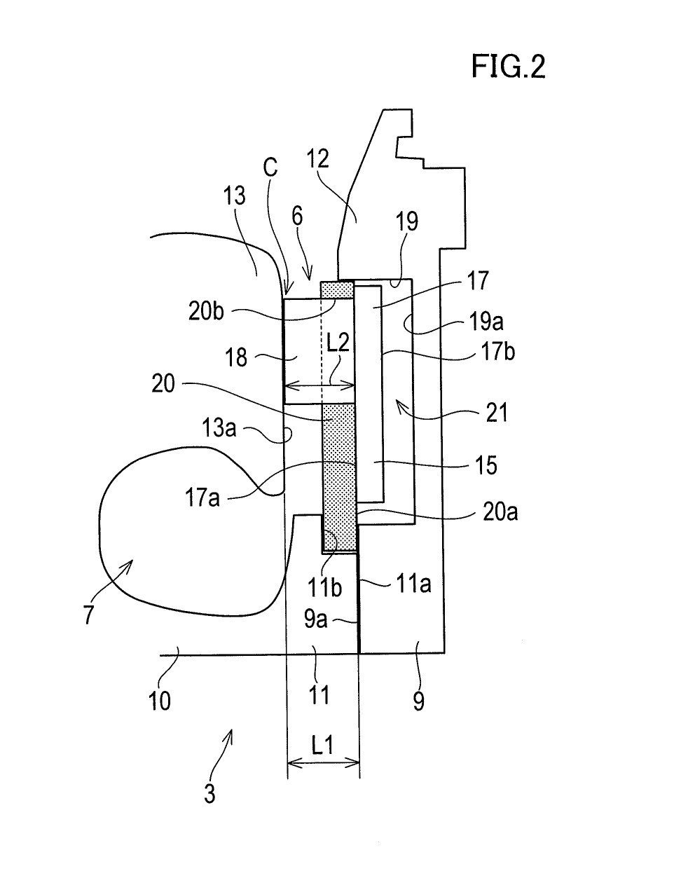

The housing assembly 3 has a bearing housing 9 serving as a first housing and a compressor housing 10 serving as a second housing. The bearing housing 9 supports the rotating shaft 8 so as to be rotatable about an axis Ax. The compressor housing 10 houses the impeller 4 inside so as to be rotatable about the axis Ax, and is assembled with the bearing housing 9 so as to be aligned in the direction of the axis Ax with it. FIG. 2 is an enlarged view of a part around the diffuser 6. As shown in this figure, the bearing housing 9 has a mounting surface 9a located in a direction perpendicular to the direction of the axis Ax. The mounting surface 9a is arranged outward in the radial direction further than the diffuser 6. The compressor housing 10 is provided with an affixing portion 11 mounted to the mounting surface 9a. The affixing portion 11 is provided with a fastening surface 11a located in a direction perpendicular to the direction of the axis Ax as with the mounting surface 9a. The compressor housing 10 is assembled with the bearing housing 9 so that the fastening surface 11a contacts the mounting surface 9a.

As shown in this figure, the diffuser 6 is formed by a first diffuser wall portion 12 which is arranged on a side of the bearing housing 9 and a second diffuser wall portion 13 which is arranged on a side of the compressor housing 10. These diffuser wall portions 12, 13 are arranged so as to be aligned in the direction of the axis Ax, and to be opposed to each other. The second diffuser wall portion 13 has a wall surface 13a forming the diffuser 6. The wall surface 13a is arranged at a position which is concaved at a distance L1 in the direction of the axis Ax from the fastening surface 11a. The first diffuser wall portion 12 is provided with a movable vane mechanism 14. The movable vane mechanism 14 has a movable vane 15 and a driving apparatus 16 which drives the movable vane 15 in the direction of the axis Ax. The driving apparatus 16 may be a known apparatus to drive the movable vane 15 in the direction of the axis Ax by transmitting a power of an actuator (not shown) to the movable vane 15 via a link mechanism and the like. Thereby, a detailed description thereof will be omitted.

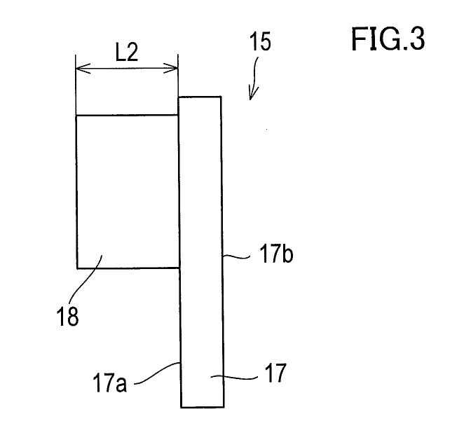

FIG. 3 is an enlarged view of the movable vane 15. As shown in this figure, the movable vane 15 has a hollow disk shaped base portion 17 and a plurality of vane portions 18 projected from the base portion 17. In this figure, only one vane portion 18 is shown. Each vane portion 18 projects toward the second diffuser wall portion 13 from the base portion 17. The base portion 17 has a facing surface 17a opposing to the second diffuser wall portion 13 and located in a direction perpendicular to the direction of the axis Ax. The vane portion 18 projects in the direction of the axis Ax from the facing surface 17a. As a projecting length L2 of the vane portions 18, set is a value which is slightly smaller than the distance L1 between the wall surface 13a of the second diffuser wall portion 13 and the fastening surface 11a.

The bearing housing 9 is provided with a concave portion 19 arranging inward in the radial direction of the mounting surface 9a and hollowing in the direction of the axis Ax from the mounting surface 9a. The concave portion 19 is formed around the entire outer periphery of the impeller 4. A diffuser plate 20 is mounted on the bearing housing 9 so as to cover the concave portion 19. As shown in this figure, the diffuser plate 20 is attached in a step portion 11b provided to the affixing portion 11 of the compressor housing 10. The diffuser plate 20 is fixed, as being sandwiched between the bearing housing 9 and the compressor housing 10. The step portion 11b is formed so as to be arranged at a position where a bearing housing side surface 20a of the diffuser plate 20 is flush with the fastening surface 11a in a case that the diffuser plate 20 is attached. Thereby, the diffuser plate 20 is mounted on the bearing housing 9 so that the bearing housing side surface 20a contacts with the mounting surface 9a. By covering the concave portion 19 by the diffuser plate 20 in this manner, a storage chamber 21 is formed in the first diffuser wall portion 12. The diffuser plate 20 becomes a part of the first diffuser wall portion 12 and forms one side of wall surface of the diffuser 6. The movable vane 15 is arranged in the storage chamber 21 so as to be movable in the direction of the axis Ax. The diffuser plate 20 is provided with penetrating holes 20b having a same shape as a cross sectional shape of the vane portion 18, and the penetrating holes 20b being equal in number to the vane portions 18. The movable vane 15 is arranged in the storage chamber 21 so that each of the vane portions 18 is inserted in the penetrating hole 20b.

Next, motion of the movable vane 15 will be described. As described above, the driving apparatus 16 drives the movable vane 15 in the direction of the axis Ax. At this moment, the driving apparatus 16 drives the movable vane 15 in the direction of the axis Ax between a projected position where the vane portions 18 are projected into the diffuser 6 and a retracted position where the vane portions 18 are retracted in the first diffuser wall portion 12. As shown in FIG. 2, at the projected position, the facing surface 17a of the movable vane 15 contacts with the bearing housing side surface 20a of the diffuser plate 20. Thereby, the position of the movable vane 15 in the projected position is decided. Accordingly, the bearing housing side surface 20a of the diffuser plate 20 corresponds to a positioning surface of the present invention. As described above, the projecting length L2 of the vane portions 18 is slightly smaller than the distance L1 between the wall surface 13a of the second diffuser wall portion 13 and the fastening surface 11a. Thereby, it is possible to prevent a collision between the vane portion 18 and the wall surface 13a in the projected position. On the other hand, at the retracted position, by contacting a surface 17b on the side opposite to the facing surface 17a of the base portion 17 with a bottom 19a of the concave portion 19, the position of the movable vane 15 is decided.

As described above, in the compressor 2 of the present invention, the bearing housing side surface 20a of the diffuser plate 20 deciding the position of the movable vane 15 in the projected position is flush with the fastening surface 11a. Thereby, as shown in FIG. 2, the size of a clearance C between the movable vane 15 and the second diffuser wall portion 13 in the projected position is decided by a difference between the distance L1 in the direction of the axis Ax between the wall surface 13a of the second diffuser wall portion 13 and the fastening surface 11a and the projecting length L2 of the vane portions 18. That is, it is possible to manage the size of the clearance C by managing two sizes which are the size of the distance L1 and the size of the projecting length L2. By decreasing portions to be managed about the size to two portions, it is possible to suppress an influence which is given to the size of the clearance C by a machining error of each portions and an assembly error. Thereby, it is possible to suppress varying the size of the clearance C for each product. By decreasing the number of portions to be managed about the size, it is possible to easily manage the sizes of these portions. In the compressor 2, by making the projecting length L2 of the vane portion 18 slightly smaller than the distance L1, it is possible to form the clearance C. Thereby, it is possible to prevent the vane portions 18 from deforming. Since the size of the clearance C is decided by only the size of the distance L1 and the size of the projecting length L2, it is possible to manage the size of the clearance C accurately. Thereby, it is possible to decrease the size of the clearance C while forming the clearance C between the movable vane 15 in the projected position and the second diffuser wall portion 13.

### Second Embodiment

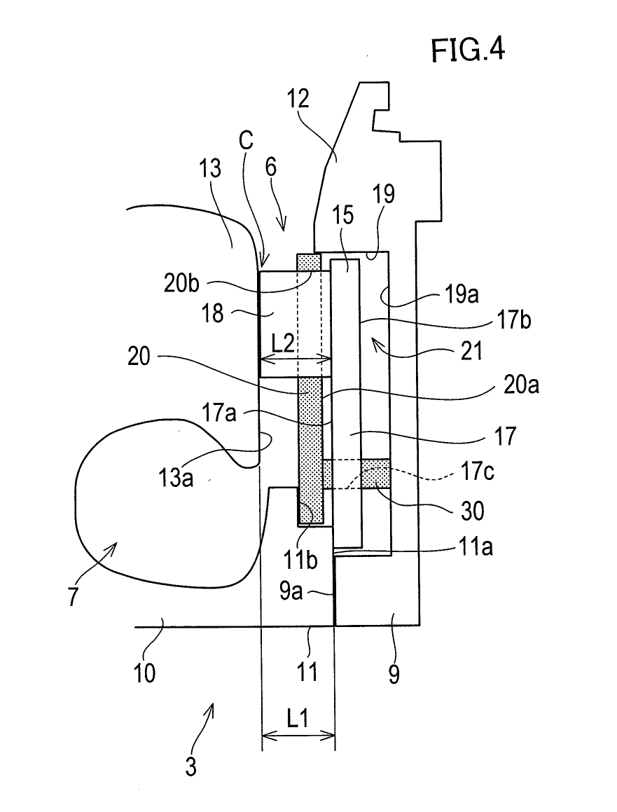

The centrifugal compressor according to a second embodiment of the present invention will be described with reference to FIG. 4. In this embodiment, the same components as those in the first embodiment are denoted by the same reference numeral, and descriptions thereof will be omitted. FIG. 4 is a figure corresponding to FIG. 2 for the first embodiment. The components which is not shown in FIG. 4 is the same as the first embodiment, thus descriptions thereof will be omitted.

As shown in this figure, in the present embodiment, by covering the concave portion 19 with the diffuser plate 20 and a part of the fastening surface 11a of the compressor housing 10, the storage chamber 21 is formed. The diffuser plate 20 is arranged so that the bearing housing side surface 20a is located closer to the second diffuser wall portion 13 than the fastening surface 11a. For fixing the diffuser plate 20 in such position, the diffuser plate 20 is provided with a support member 30 extending in the direction of the axis Ax from the bearing housing side surface 20a. The base portion 17 of the movable vane 15 is provided with a penetrating hole 17c penetrating in the direction of the axis Ax. The support member 30 is inserted in the penetrating hole 17c. As shown in this figure, in the present embodiment, the size of the base portion 17 is set so that the facing surface 17a of the movable vane 15 in the projected position contacts the fastening surface 11a. Namely, in the present embodiment, the position of the movable vane 15 in the projected position is decided by the fastening surface 11a of the compressor housing 10. Thereby, a part which covers the concave portion 19 in the fastening surface 11a corresponds to a positioning surface of the present invention. In the present embodiment, the projecting length L2 of the vane portions 18 is also set as a value which is slightly smaller than the distance L1 between the wall surface 13a of the second diffuser wall portion 13 and the fastening surface 11a.

According to the second embodiment, the position of the movable vane 15 in the projected position is decided by the fastening surface 11a. Thereby, similarly to the above described first embodiment, the size of the clearance C between the movable vane 15 in the projected position and the second diffuser wall portion 13 is decided by the difference between the distance L1 between the wall surface 13a of the second diffuser wall portion 13 and the fastening surface 11a and the projecting length L2 of the vane portions 18. Accordingly, it is possible to decrease the portions to be managed about the size for decreasing the clearance C to two portions. Thereby, it is possible to suppress varying the size of the clearance C for each product. It is possible to manage the sizes of the portions which can influence the size of the clearance C easily. In the second embodiment, since the projecting length L2 of the vane portions 18 is slightly smaller than the distance L1, it is possible to prevent the vane portions 18 from deforming. In this embodiment, since the position of the movable vane 15 is decided directly by the fastening surface 11a, it is possible to increase the positioning accuracy for the movable vane 15 in the projected position. Thereby, since it is possible to manage the size of the clearance C further accurately, it is possible to decrease the size of the clearance C further.

The present invention is not limited to the above-described embodiments, and may be executed in various modes. For example, the centrifugal compressor of the present invention may be used alone without being incorporated into the turbo supercharger.

1. A centrifugal compressor comprising:
a housing assembly that includes a first housing which supports a rotating shaft so as to be rotatable about an axis, the rotating shaft having an impeller on an end portion of itself, and a second housing which houses the impeller inside and is assembled with the first housing so as to be aligned in the direction of the axis with the first housing, wherein a diffuser serving as a passage space communicated with an exit side of the impeller is formed by a first diffuser wall portion of a first housing side and a second diffuser wall portion of a second housing side on outer periphery of the impeller, and
a movable vane that includes a base portion which is arranged in a storage chamber provided in the first diffuser wall portion and has a facing surface opposing to the second diffuser wall portion, and vane portions which project from the facing surface to a second diffuser wall portion side, wherein
the movable vane is movable in the direction of the axis between
a projected position where the facing surface contacts with a positioning surface provided in the storage chamber and the vane portions project in the diffuser and
a retracted position where the vane portions are retracted to a first diffuser wall portion side further than the projected position, wherein
the first housing is provided with a mounting surface located in a direction perpendicular to the direction of the axis,
the second housing includes an affixing portion projecting to the first housing side further than the second diffuser wall portion, and a fastening surface being provided to the affixing portion and located in a direction perpendicular to the direction of the axis, wherein the second housing is assembled with the first housing by attaching the fastening surface to the mounting surface, and
the positioning surface is provided in the storage chamber so as to be flush with the fastening surface.

2. The centrifugal compressor according to claim 1, wherein
the first diffuser wall portion is provided with a concave portion hollowing in the direction of the axis further than the mounting surface and housing the base portion so as to be movable in the direction of the axis to become the storage chamber,
the fastening surface is attached to the mounting surface so that a part of the fastening surface covers at least a part of the concave portion, and
the positioning surface is the part of the fastening surface covering the concave portion.

3. A turbo supercharger comprising
the centrifugal compressor according to claim 1 and a turbine, wherein
the centrifugal compressor is provided to an intake passage of an internal combustion engine and the turbine is provided to an exhaust passage of the internal combustion engine,
the turbine recovers exhaust energy of the internal combustion engine, and the turbo supercharger supercharges the internal combustion engine by driving to rotate the impeller of the centrifugal compressor by recovered exhaust energy.

4. A turbo supercharger comprising
the centrifugal compressor according to claim 2 and a turbine, wherein
the centrifugal compressor is provided to an intake passage of an internal combustion engine and the turbine is provided to an exhaust passage of the internal combustion engine,
the turbine recovers exhaust energy of the internal combustion engine, and the turbo supercharger supercharges the internal combustion engine by driving to rotate the impeller of the centrifugal compressor by recovered exhaust energy.
